(19) United States
(12) Patent Application Publication
(10) Pub. No.: US 2004/0128407 A1
(43) Pub. Date: Jul. 1, 2004

(54) ATA device programming time

(76) Inventor: Joseph A. Bennett, Roseville, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/334,811

(22) Filed: Dec. 31, 2002

(51) Int. Cl. G06F 13/28

(52) U.S. Cl. 710/22

(57) ABSTRACT

One embodiment involves having a processor writing disk drive command information to cacheable system memory. The processor then performs a single write transaction to a disk drive host controller. The host controller then causes a DMA transfer to occur which reads the command information located in system memory. Once the host controller has the command information, it programs the disk drive over an interconnect. Because the processor can write to cacheable system memory space much quicker than it can perform non-cacheable memory writes to the host controller or programmed I/O writes to the disk drive, the processor is freed up to perform other tasks and overall system performance is improved.

### FIELD OF THE INVENTION

The present invention pertains to the field of computer systems. More particularly, this invention pertains to the field of programming mass storage devices.

### BACKGROUND OF THE INVENTION

Typical computer systems utilize disk drives for mass storage. A disk drive is usually coupled to a host controller that resides in a system logic device. The disk drive is coupled to the host controller via an interconnect. One such interconnect is an AT Attachment (ATA) interconnect. The host controller communicates with the disk drive over the ATA interconnect.

In prior computer systems, in order to program a disk drive to initiate a data transfer, a processor must perform a series of one byte write cycles (anywhere between 8 and 16) to the ATA interface. This programming operation can take a significant amount of time and keep the processor from performig other tasks.

Prior methods to improve the above situation include using “fast” timings on the ATA interconnect or having the processor perform non-cacheable memory write cycles to the host controller and letting the host controller manage the programming task. Both of these prior methods require a significant amount of processor time.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 is a block diagram of a computer system including an input/output controller hub that includes a direct memory access (DMA) unit and a storage device host controller.

FIG. 2 is a flow diagram of a method for improving disk drive programming times.

### DETAILED DESCRIPTION

In general, one embodiment involves having a processor writing disk drive command information to cacheable system memory. The processor then performs a single write transaction to a disk drive host controller. The host controller then causes a DMA transfer to occur which reads the command information located in system memory. Once the host controller has the command information, it programs the disk drive over an interconnect. Because the processor can write to cacheable system memory space much quicker than it can perform non-cacheable memory writes to the host controller or programmed I/O writes to the disk drive, the processor is freed up to perform other tasks and overall system performance is improved.

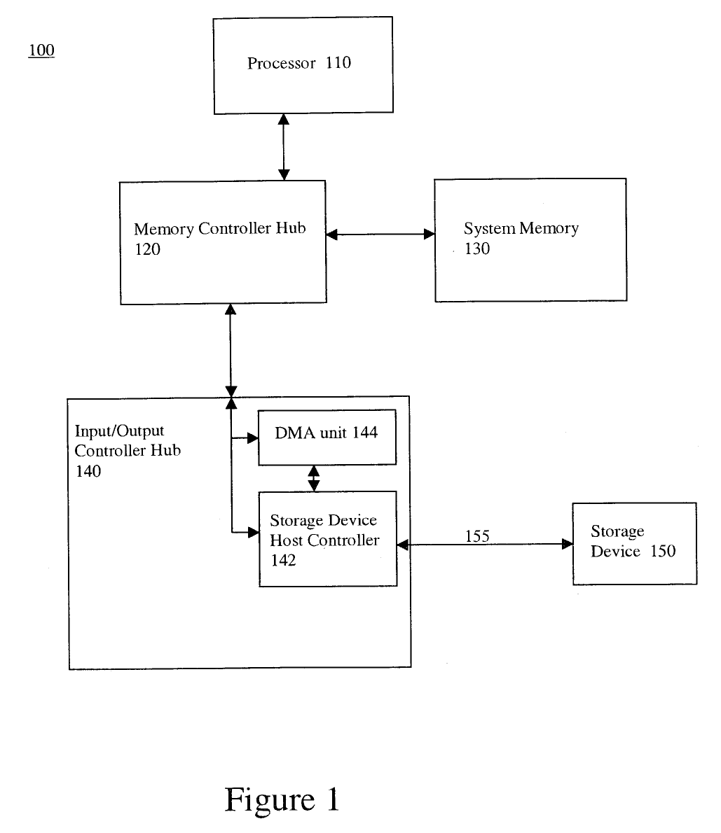

FIG. 1 is a block diagram of a computer system 100 including an input/output controller hub 140 that includes a direct memory access (DMA) unit 144 and a storage device host controller 142. The system 100 further includes a processor 110, a memory controller hub 120, and a system memory 130. The processor 110 communicates with the input/output hub 140 or the system memory 130 through the memory controller hub 120. One embodiment may include a processor from the family of Pentium® processors from Intel® Corporation. Other embodiments may use other types of processors or micro-controllers.

The system 100 also includes a storage device 150 coupled to the storage device host controller 142 via an interconnect 155. For this embodiment, the interconnect 155 is a serial ATA interconnect, although other embodiments are possible using other types of interconnects. The storage device 150 in this example embodiment is a disk drive.

The configuration of the system 100 is only one of a wide variety of configurations possible.

In the current example embodiment, when the storage device 150 needs to be programmed in order to initiate a data transfer, the processor 110 writes a command block to the system memory 130. The command block includes information necessary for the storage device 150 to perform a data transfer. For this example embodiment, the command block includes 16 bytes of information. Other embodiments are possible using other sizes of command blocks. Also for this embodiment, the command block is stored in cacheable memory space.

Following the write of the command block to system memory 130, the processor performs a single write cycle to the storage device host controller 142. The write may be to a register within the host controller 142 or to a register located elsewhere within the input/output controller hub 140. The write cycle from the processor 110 informs the host controller 142 that a command block has been written to the system memory 130. The information conveyed by the write cycle may also include information regarding the location of the command block in system memory.

In response to the write cycle from the processor 110, the host controller 142 causes a DMA transfer to occur to read the command block from the system memory 130. The DMA transfer may be performed by the DMA unit 144. The DMA read may occur in a burst fashion. The retrieved command block may be stored in a storage location within the host controller 142.

Once the command block is retrieved from the system memory 130, the host controller 142 delivers the command block information to the storage device 150 over the interconnect 155. In this way, the processor 110 only needs to write the command block to the system memory 130 and perform a single write cycle to the host controller 142 in order to program the storage device 150.

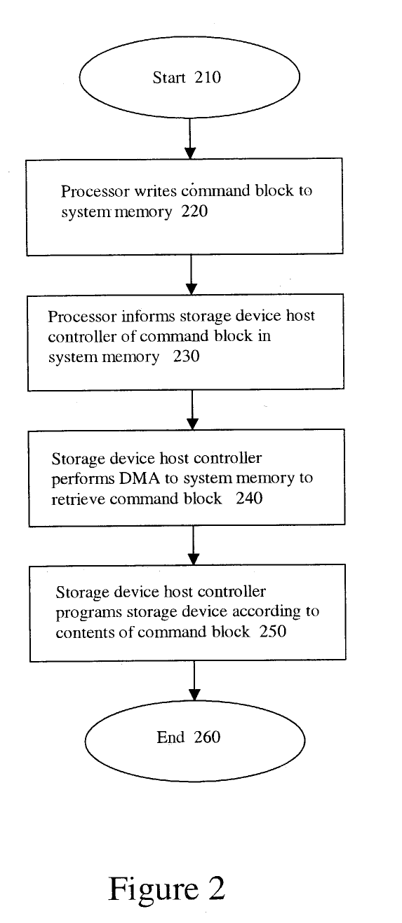

FIG. 2 is a flow diagram of one embodiment of a method for improving disk drive programming times. The process begins at block 210. At block 220, a processor writes a command block to system memory. The processor then informs the storage device host controller of the command block in system memory at block 230. At block 240, the storage device host controller causes a DMA transfer to be performed to retrieve the command block from system memory. The storage device host controller programs the storage device according to the contents of command block at block 250. The programming process ends at block 260.

In the foregoing specification the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than in a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances of “an embodiment,” “one embodiment,” or “some embodiments” are not necessarily all referring to the same embodiments.

What is claimed is:

1. An apparatus, comprising:
a storage device host controller to receive an indication from a processor that a command block has been written to a memory device; and
a direct memory access unit to retrieve the command block from the memory device.

2. The apparatus of claim 1, the storage device host controller to deliver programming information to a storage device, the programming information corresponding to the command block.

3. The apparatus of claim 2, the storage device host controller including a serial ATA host controller.

4. The apparatus of claim 3, wherein the storage device is a disk drive.

5. The apparatus of claim 4, the memory device included in system memory.

6. A method, comprising:
receiving at a storage device host controller an indication that a command block has been written to a memory device; and
retrieving the command block from the memory device.

7. The method of claim 6, wherein receiving at a storage device host controller an indication that a command block has been written to a memory device includes receiving at the storage device host controller an indication from a processor that the command block has been written to the memory device.

8. The method of claim 7, wherein retrieving the command block from the memory device includes retrieving the command block from the memory device using a direct memory access unit.

9. The method of claim 8, further comprising delivering programming information from the storage device host controller to a storage device, the programming information corresponding to the command block.

10. The method of claim 9, wherein delivering programming information from the storage device host controller to a storage device includes delivering programming information from a serial ATA host controller to the storage device.

11. The method of claim 10, wherein delivering programming information from the storage device host controller to the storage device includes delivering programming information from the storage device host controller to a disk drive.

12. The method of claim 11, wherein receiving at a storage device host controller an indication that a command block has been written to a memory device includes receiving at a storage device host controller an indication that a command block has been written to a system memory.

13. The method of claim 12, wherein retrieving the command block from the memory device includes retrieving the command block from the system memory.

14. A system, comprising
a processor;
a memory controller coupled to the processor;
a system memory coupled to the memory controller; and
a system logic device coupled to the memory controller, the system logic device including
a storage device host controller to receive an indication from the processor that a command block has been written to the system memory, and
a direct memory access unit to retrieve the command block from the system memory.

15. The system of claim 14, further comprising a storage device coupled to the storage device host controller, the storage device host controller to deliver programming information to the storage device, the programming information corresponding to the command block.

16. The system of claim 15, wherein the storage device host controller is serial ATA host controller.

17. The system of claim 16, wherein the storage device is a disk drive.
